(19) United States
(12) Patent Application Publication
(10) Pub. No.: US 2008/0225222 A1
(43) Pub. Date: Sep. 18, 2008

(54) LIQUID CRYSTAL DISPLAY DEVICE AND METHOD OF MANUFACTURING THE SAME

(75) Inventor: Seiya UEDA, Kumamoto (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 12/045,993

(22) Filed: Mar. 11, 2008

(30) Foreign Application Priority Data
Mar. 13, 2007 (JP) 2007-064092

(51) Int. Cl. G02F 1/1339; G02F 1/13

(52) U.S. Cl. 349/154; 349/190

(57) ABSTRACT

A method of manufacturing a liquid crystal display device forms a seal pattern having a liquid crystal inlet seal pattern across a cutting-plane line above a mother substrate where a plurality of panels are arranged in matrix with the cutting-plane line interposed therebetween, and cuts the mother substrate at the cutting-plane line into the plurality of panels. The method includes coating an organic film, patterning the organic film to form an organic film removal area placed along the cutting-plane line and including a wide portion where the organic film removal area is wide with a boundary with the organic film being curved, coating a photosensitive resin over the organic film, forming the liquid crystal inlet seal pattern in the wide portion of an adjacent panel, and cutting the mother substrate at the cutting-plane line so as to divide the liquid crystal inlet seal pattern.

### BACKGROUND OF THE INVENTION

1. Field of the Invention

The present invention relates to a liquid crystal display device and a method of manufacturing the same.

2. Description of Related Art

The development of high definition technology for liquid crystal display devices has progressed recently, and there are demands for higher functions, higher added values and lower costs. Particularly, the demand for lower costs is increasing. In order to reduce costs, it is necessary to place panels as many as possible on one mother substrate in a small-size liquid crystal display device such as a cellular phone and a digital camera.

The number of panels on one mother substrate increases by minimizing an extra space between panels. Further, a maximum number of panels on one substrate can be obtained by eliminating the interval between panels in the up, down, left and right directions.

A liquid crystal display device includes a transmissive liquid crystal display device which displays an image with a backlight placed at the back, and a reflective liquid crystal display device which displays an image with a reflective plate placed on a substrate to reflect ambient light on the surface of the reflective plate. The transmissive liquid crystal display device has a concern that a display is difficult to see when ambient light is very bright light such as direct sunlight because display light is darker than the ambient light. On the other hand, the reflective liquid crystal display device has a concern that the visibility decreases significantly when ambient light is dark.

In light of the above concerns, a transflective liquid crystal display device which transmits a part of light and reflects a part of light is proposed. In the transflective liquid crystal display device, an organic film which has an irregular pattern on its surface is placed on an insulating film in order to obtain good scattering characteristics (Japanese Unexamined Patent Application Publication No. 2004-294805). For example, in this technique, the organic film is coated over the insulating film by spin coating and then patterning is performed to form depressions on the surface of the organic film by photolithography process, thereby creating the irregular pattern on the surface of the organic film. Thus, the thickness of the organic film is 3 to 4 μm, which is much thicker than another element such as a metal film.

While the organic film is patterned into a prescribed shape within a display region, it is formed on the whole area, without being patterned, outside the display region, which is within a frame region. However, in the case of placing a plurality of panels on one mother substrate, the organic film above a panel cutting-plane line stands as an obstacle to deteriorate the cutting accuracy. Further, if the organic film is formed all over the frame region, there are drawbacks such as a decrease in the bonding strength of a FPC terminal and a difficulty in reading an alignment mark for mounting. To avoid this, the organic film is removed in the vicinity of above the panel cutting-plane line, the FPC terminal bonding portion and the mounting alignment mark.

Further, in a recent liquid crystal display device, panels are placed in such a way that the interval between the panels is zero in each of the up, down, left and right directions in order to maximize the number of panels to be obtained therefrom. In this case, a seal pattern is placed in such a way that a part of the seal pattern projects to the adjacent panel. Generally, in the seal pattern, an inlet seal pattern which forms a liquid crystal inlet (filling port) sticks out beyond a seal frame which surrounds the display region. Placing a part of the inlet seal pattern so as to project to the adjacent panel ensures an inlet to allow easy filling of liquid crystal in consideration of the accuracy of position of the seal pattern, the displacement during panel cutting or the like. The inlet seal pattern is referred to hereinafter as a protrusion of a seal pattern. The seal pattern protrusion is placed in the vicinity of the FPC terminal bonding portion and the mounting alignment mark due to space constraints. In order to avoid the stripping of the seal pattern, the organic film is removed also in the vicinity of the seal pattern protrusion.

FIG. 11 is a view showing the patterned shape of an organic film 8 in a frame region 42. In FIG. 11, a seal pattern 11, which is formed in a subsequent panel bonding process, is indicated by a dotted line for convenience of description. In FIG. 11, the organic film 8 is removed above the panel cutting-plane line 10 which is adjacent to a side of the seal frame that has an inlet and in its vicinity, so that an organic film removal area (organic film removal area 13) is placed in stripe along the cutting-plane line. Further, the organic film above the FPC terminal bonding portion is removed in the area (organic film removal area 14) which extends from the stripe-shaped organic film removal area 13 along the cutting-plane line. Likewise, the organic film in the seal pattern protrusion portion and its vicinity is removed in rectangular shape in the area (organic film removal area 16) which extends from the stripe-shaped organic film removal area 13 along the cutting-plane line. Further, the organic film is removed in the area (organic film removal area 15) above the mounting alignment mark and its vicinity.

As described above, in the frame region 42, the organic film removal area 16 in the area of the seal pattern protrusion 12 extends from the organic film removal area 13 along the panel cutting-plane line 10, so that the organic film 8 is removed in projecting shape when viewed from above.

However, if the projecting organic film removal area is placed in the frame region 42, it can cause unevenness when a resist is coated by spin coating in a subsequent step. As shown in FIG. 12, coating unevenness 17 occurs radially from the corner of the projecting organic film removal area, which is the corner of the rectangular organic film removal area that is placed in the area of the seal pattern protrusion 12. The coating unevenness 17 is generated not only within the frame region 42 but also in a wide range extending to a display region 41.

The mechanism that the coating unevenness 17 occurs is described hereinafter with reference to FIGS. 13A and 13B. FIG. 13A is a schematic view of the projecting portion of the organic film removal area in an enlarged scale, and it shows the patterned shape of the organic film 8 in the area of the seal pattern protrusion 12. FIG. 13B is a sectional view along line XIIIB-XIIIB in FIG. 13A. In FIG. 13A, the seal pattern 11, which is formed in a subsequent panel bonding process, is indicated by a dotted line for convenience of description. The organic film removal area in the frame region 42 is formed simultaneously when patterning the organic film 8 in the display region 41 into a prescribed shape. Specifically, the organic film 8 is patterned by photolithography process, and then an exposed part of an insulating film 7 is removed by dry etching. Thus, the organic film 8 and the insulating film 7 are removed in the organic film removal area, so that a step of 3 to 4 μm or higher exists between the organic film removal area and the adjacent area. Further, as shown in FIG. 13B, the side face of the organic film removal area is substantially perpendicular to a substrate 1 or steeply tapered. Accordingly, the projecting portion of the organic film removal area is surrounded by high and steep edge faces in three directions.

After the formation of the organic film removal area, a reflective electrode and a transparent electrode are formed with a metal film, for example, in a subsequent step. Specifically, a metal film is deposited, and a resist for patterning the metal film is coated thereon by spin coating. During the spin coating, the resist is easily accumulated in the projecting portion (especially, the corner) of the organic film removal area because it is surrounded by the high and steep edge faces in three directions. When the resist is accumulated to saturation, the accumulated resist is let out from the corner of the projecting portion, which causes the radial coating unevenness 17.

Although the film thickness of the resist is substantially uniform in the area without the coating unevenness 17, the film thickness of the resist is nonuniform in the area where the coating unevenness 17 occurs. Thus, the area with the coating unevenness 17 has a thicker or thinner resist compared with the area without the coating unevenness 17. If the film thickness of the resist is large, the part of the resist to be removed can remain without being removed. Therefore, the resist is not patterned into a desired shape in the area having the coating unevenness 17. Further, because a metal film is etched through such a resist pattern, a desired shape cannot be obtained in the area having the coating unevenness 17. In a display device which uses such a panel, display unevenness or the like occurs to cause the degradation of a display quality and a yield.

In view of the foregoing, there is a need for a liquid crystal display device with a high display quality and a method of manufacturing the same.

### SUMMARY OF THE INVENTION

According to an embodiment of the present invention, there is provided a method of manufacturing a liquid crystal display device that forms a seal pattern having a liquid crystal inlet seal pattern across a cutting-plane line above a mother substrate where a plurality of panels are arranged in matrix with the cutting-plane line interposed therebetween and cuts the mother substrate at the cutting-plane line into the plurality of panels. The method includes coating an organic film over the mother substrate, patterning the organic film to form an organic film removal area placed along the cutting-plane line and including a wide portion where the organic film removal area is wide with a boundary with the organic film being curved, coating a photosensitive resin over the patterned organic film, forming a seal pattern surrounding a display region of each panel above the mother substrate and forming the liquid crystal inlet seal pattern in the wide portion of an adjacent panel, and cutting the mother substrate at the cutting-plane line so as to divide the liquid crystal inlet seal pattern.

The present invention provides a liquid crystal display device with a high display quality and a method of manufacturing the same.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a front view showing the structure of a TFT array substrate according to a first embodiment of the present invention;

FIG. 2 is a sectional view showing the exemplary structure of a TFT array substrate of a transflective liquid crystal display device according to the first embodiment;

FIG. 3 is a plane view showing a panel layout according to the first embodiment;

FIG. 4 is a view showing the layout of a seal pattern according to the first embodiment;

FIG. 5 is a schematic view showing a patterned shape of an organic film in a frame region according to the first embodiment;

FIG. 6 is a plane view showing a patterned shape of an organic film in a seal pattern protrusion area according to the first embodiment;

FIG. 7 is a plane view showing a patterned shape of an organic film in a seal pattern protrusion area according to a second embodiment of the present invention;

FIG. 8 is a plane view showing a patterned shape of an organic film in a seal pattern protrusion area according to a third embodiment of the present invention;

FIG. 9A is a plane view showing a patterned shape of an organic film in a seal pattern protrusion area according to a fourth embodiment of the present invention;

FIG. 9B is a sectional view along line IXB-IXB in FIG. 9A;

FIG. 10A is a plane view showing a patterned shape of an organic film in a seal pattern protrusion area according to a fifth embodiment of the present invention;

FIG. 10B is a sectional view along line XB-XB in FIG. 10A;

FIG. 11 is a schematic view showing a patterned shape of an organic film in a frame region according a related art;

FIG. 12 is a view showing coating unevenness in a subsequent step due to a patterned shape of an organic film in a frame region according to the related art;

FIG. 13A is a plane view showing a patterned shape of an organic film in a seal pattern protrusion area according to the related art; and

FIG. 13B is a sectional view along line XIIIB-XIIIB in FIG. 13A.

### DESCRIPTION OF THE PREFERRED EMBODIMENTS

### First embodiment

A liquid crystal display device according to an embodiment of the present invention is described hereinafter with reference to FIG. 1. FIG. 1 is a front view showing the structure of a TFT array substrate which is used in a liquid crystal display device. The overall structure of the liquid crystal display device is common among the first to fifth embodiments described hereinbelow.

The liquid crystal display device according to the embodiment of the present invention includes an insulating substrate 1. The substrate 1 may be an array substrate such as a TFT array substrate. The substrate 1 includes a display region 41 and a frame region 42 which surrounds the display region 41. In the display region 41, a plurality of gate lines (scan signal lines) 43 and a plurality of source lines (display signal lines) 44 are placed. The plurality of gate lines 43 are arranged in parallel. Likewise, the plurality of source lines 44 are arranged in parallel. The gate lines 43 and the source lines 44 cross each other. The gate lines 43 and the source lines 44 are orthogonal to each other. The area which is surrounded by the adjacent gate lines 43 and the source lines 44 serves a pixel 47. Thus, the pixels 47 are arranged in matrix on the substrate 1.

In the frame region 42 of the substrate 1, a scan signal driving circuit 45 and a display signal driving circuit 46 are placed. The gate line 43 extends from the display region 41 to the frame region 42. The gate line 43 is connected to the scan signal driving circuit 45 at the end of the substrate 1. The source line 44 also extends from the display region 41 to the frame region 42. The source line 44 is connected to the display signal driving circuit 46 at the end of the substrate 1. An external line 48 is placed in the vicinity of the scan signal driving circuit 45. An external line 49 is placed in the vicinity of the display signal driving circuit 46. The external lines 48 and 49 may be wiring boards such as a flexible printed circuit (FPC).

Various signals are supplied from the outside to the scan signal driving circuit 45 and the display signal driving circuit 46 through the external lines 48 and 49, respectively. The scan signal driving circuit 45 supplies a gate signal (scan signal) to the gate line 43 according to a control signal from the outside. By the gate signal, the gate lines 43 are selected sequentially. The display signal driving circuit 46 supplies a display signal to the source line 44 according to a control signal from the outside or display data. A display voltage corresponding to the display data is thereby supplied to each pixel 47. The scan signal driving circuit 45 and the display signal driving circuit 46 are not necessarily placed on the substrate 1. For example, the driving circuits may be connected by using tape carrier package (TCP).

At least one thin film transistor (TFT) 50 is placed in the pixel 47. The TFT 50 is located in the vicinity of the intersection between the gate line 43 and the source line 44. For example, the TFT 50 operates to supply a display voltage to a pixel electrode. Specifically, the TFT 50, which is a switching element, is turned on by the gate signal from the gate line 43. A display voltage is thereby applied from the source line 44 to the pixel electrode which is connected to a drain electrode of the TFT 50. Then, an electric field corresponding to the display voltage is generated between the pixel electrode and a counter electrode. An alignment layer (not shown) is placed on the surface of the substrate 1.

A counter substrate is placed opposite to the substrate 1. The counter substrate may be a color filter substrate, for example, which is located at the viewing side. In the counter substrate, a color filter, a black matrix (BM), a counter electrode, an alignment layer and so on are placed. The counter electrode may be placed in the substrate 1 instead. A liquid crystal layer is placed between the substrate 1 and the counter substrate. In other words, liquid crystal is filled between the substrate 1 and the counter substrate. Further, a polarization plate, a retardation film and so on are placed on the outside surfaces of the substrate 1 and the counter substrate. Further, a backlight unit or the like is placed at the non-viewing side of the liquid crystal panel.

The liquid crystal is driven by the electric field between the pixel electrode and the counter electrode. The orientation of the liquid crystal between the substrates thereby changes. The polarization state of the light which passes through the liquid crystal layer changes accordingly. The light which passes through the polarization plate becomes linearly polarized light, and it further changes its polarization state by passing through the liquid crystal layer. Specifically, the light from the backlight unit becomes linearly polarized light by the polarization plate on the array substrate side. Then, the linearly polarized light passes through the liquid crystal layer, so that its polarization state changes.

Therefore, the amount of light which passes through the polarization plate on the counter substrate side varies depending on the polarization state. Specifically, the amount of the light which passes through the polarization plate at the viewing side, out of the transmitted light which is transmitted from the backlight unit to the liquid crystal display panel, varies. The orientation of the liquid crystal varies depending on a display voltage to be applied. It is therefore possible to change the amount of light which passes through the polarization plate at the viewing side by controlling the display voltage. A desired image can be displayed by varying the display voltage for each pixel.

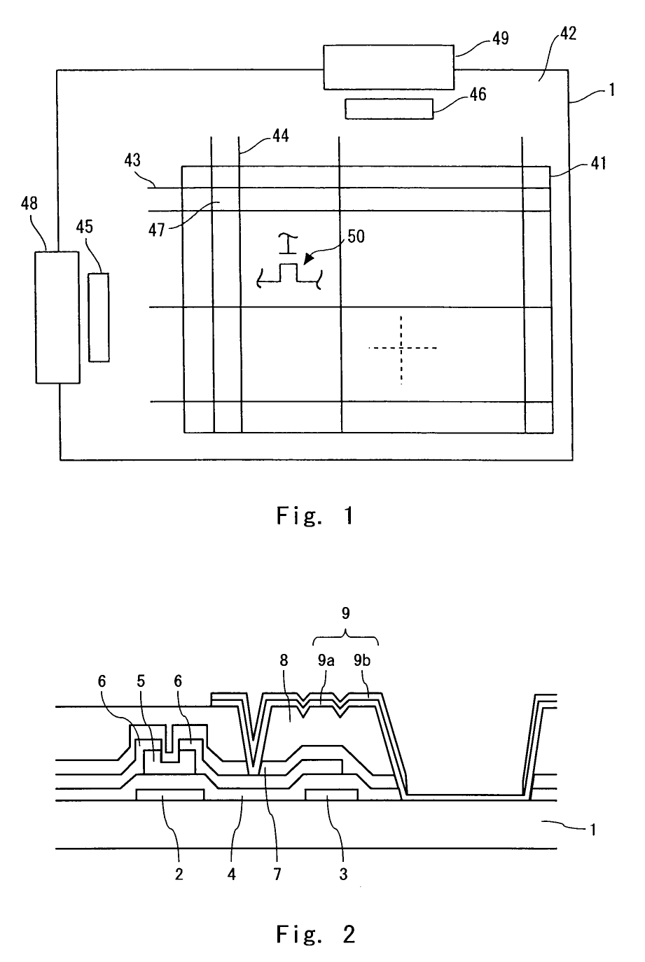

The sectional structure of the TFT array substrate which is used for the transflective liquid crystal display device is described hereinafter with reference to FIG. 2. FIG. 2 is a sectional view showing the exemplary structure of the TFT array substrate of the transflective liquid crystal display device according to this embodiment. As shown in FIG. 2, a gate electrode 2 and an auxiliary capacitor electrode 3 are formed using a first electrode film on the substrate 1. Agate insulating film 4 is formed using a first insulating film so as to cover the gate electrode 2 and the auxiliary capacitor electrode 3. A semiconductor layer 5 is placed above the gate insulating film 4, and a source/drain electrode 6 is formed thereon using a metal layer. Further, an insulating film 7 is placed so as to cover the source/drain electrode 6.

An organic film 8 is formed on the insulating film 7. In a reflecting portion of a pixel electrode, the organic film 8 has an irregular pattern on its surface. In a transmitting portion of a pixel electrode, the organic film 8, the gate insulating film 4 and the insulating film 7 are removed. A pixel electrode 9 is placed thereon. As the pixel electrode 9, a transparent electrode 9a, such as indium-tin-oxide (ITO), is placed in the transmitting portion, and a reflective electrode 9b, such as chromium, is further placed thereon in the reflecting portion. In this manner, the organic film 8 is patterned into a desired shape in the display region 41.

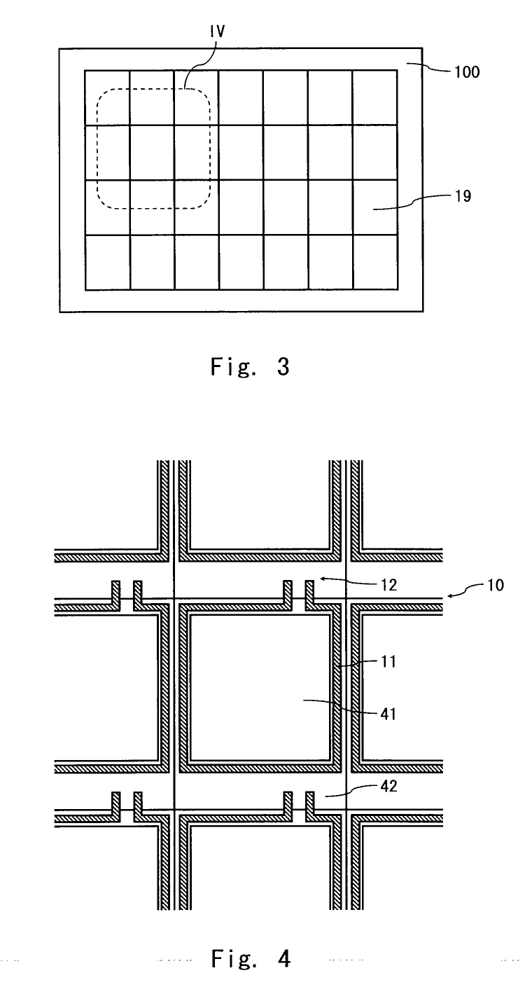

The above liquid crystal display device is generally produced by cutting and using one of a plurality of panels which are placed on one mother substrate. FIG. 3 is a plane view showing the panel layout in the mother substrate. As shown in FIG. 3, a plurality of panels 19 are arranged on a mother substrate 100 in such a way that the intervals in the up, down, left and right directions are zero. Thus, the plurality of panels 19 are arranged in matrix with a cutting-plane line placed between adjacent panels. The layout of a seal pattern is described hereinafter with reference to FIG. 4. FIG. 4 is a view showing the layout of the seal pattern, which is an enlarged view of the area IV in FIG. 3. In the example of FIG. 4, a seal pattern 11 which includes a frame-like seal pattern surrounding the display region 41 and a liquid crystal inlet seal pattern projecting from the frame-like seal pattern is formed. The liquid crystal inlet seal pattern is referred to hereinafter as a seal pattern protrusion 12. The seal pattern protrusion 12 is formed across a cutting-plane line 10 so as to project to the adjacent panel 19. Thus, in the frame region 42 of the panel 19, the seal pattern protrusion 12 is placed in an edge side which is opposite to the edge side of the substrate having the liquid crystal inlet (filling port).

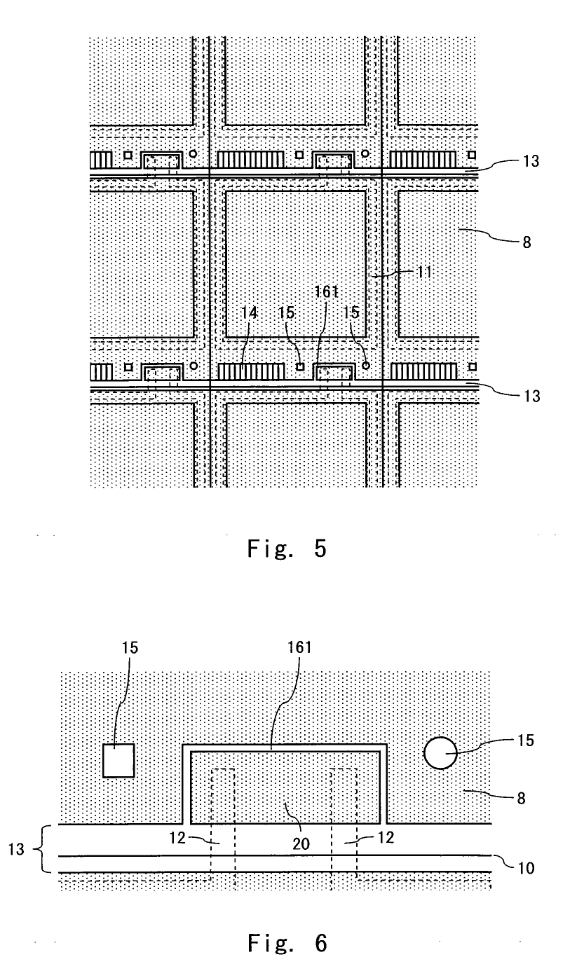

The patterned shape of the organic film 8 in the frame region 42 is described hereinafter with reference to FIGS. 5 and 6. FIG. 5 is a schematic view showing the patterned shape of the organic film 8 in the frame region 42. FIG. 6 is a plane view showing the organic film removal area in the seal pattern protrusion 12 in an enlarged scale. In FIGS. 5 and 6, the seal pattern 11, which is formed in a subsequent panel bonding process, is indicated by a dotted line for convenience of description.

In FIG. 5, just like the related art shown in FIG. 11, a stripe-shaped organic film removal area (organic film removal area 13) is placed along the panel cutting-plane line 10 which is adjacent to one of the four sides of a frame-like seal frame which has an inlet. Further, the organic film is removed in the area (organic film removal area 15) above the mounting alignment mark and its vicinity. Furthermore, the organic film is removed above the FPC terminal bonding portion in the area (organic film removal area 14) which extends from the stripe-shaped organic film removal area 13 along the cutting-plane line. In addition, in this embodiment, a slit pattern where the organic film is removed is formed in substantially U-shape (organic film removal area 161) so as to surround the seal pattern protrusion 12, which also extends from the stripe-shaped organic film removal area 13, as shown in FIG. 6 in an enlarged scale.

The width of the substantially U-shaped slit pattern which forms the organic film removal area 161 is preferably narrower, and a slit pattern with a width of about 5 μm is formed in this example. The organic film remains without being removed inside the U-shaped slit pattern. Thus, an island-shaped isolated pattern 20 is formed in a rectangular opening. The rectangular isolated pattern 20 is separated from the organic film 8 of the display region 41. The isolated pattern 20 is placed between the organic film removal area 161 and the cutting-plane line 10. The isolated pattern 20 is surrounded in three sides by the substantially U-shaped organic film removal area 161, and it is adjacent in one side to the organic film removal area 13. The seal pattern protrusion 12 is formed to across the cutting-plane line 10, and the end portion of the seal pattern protrusion 12 is placed above the isolated pattern 20.

A method of manufacturing the liquid crystal display device according to the first embodiment of the present invention is described hereinafter. First, a first electrode film is deposited on the substrate 1. For example, chromium, molybdenum, tantalum, titanium, aluminum, copper, alloys in which another material is added to the above materials, or stacked films of the above materials may be used. Then, the gate electrode 2 and the auxiliary capacitor electrode 3 are patterned by photolithography process. Further, the gate insulating film 4 is formed to cover the gate electrode 2 and the auxiliary capacitor electrode 3. The semiconductor layer 5 is formed on the gate insulating film 4. When forming the semiconductor layer 5, a film such as amorphous silicon or polysilicon is patterned in the portion where a TFT is to be formed. Further, a second metal film is deposited by sputtering or the like, and it is patterned so as to form the source/drain electrode 6 by photolithography process. Further, the insulating film 7 is formed by plasma chemical vapor deposition (CVD).

Next, the organic film 8 is formed. In this embodiment, the organic film 8 which has organic film removal areas in the frame region 42 is formed as follows. First, the organic film 8 is coated on the insulating film 7 by spin coating. The organic film 8 is a known photosensitive organic film, and PC335 or PC405 available from JSR Corporation may be used, for example. The organic film 8 is applied at a thickness of 3 to 4 μm. Then, the organic film 8 is patterned by photolithography process. The organic film 8 is thereby patterned into a desired shape in the display region 41, and the organic film 8 in the organic film removal area is thereby removed in the frame region 42. Specifically, the organic film 8 is removed in stripe in the area (organic film removal area 13) along the cutting-plane line 10, and the organic film 8 is also removed in substantially U-shape in the area (organic film removal area 161) adjacent to the stripe-shaped organic film removal area. Further, the organic film 8 in the area of the FPC terminal bonding portion and the mounting alignment mark and their vicinity (organic film removal areas 14 and 15) is removed. After that, the exposed part of the insulating film 7 and the gate insulating film 4 is removed by dry etching.

After forming the organic film 8, the pixel electrode 9 is formed. First, a transparent conductive film such as ITO, SnO₂ or IZO is deposited by sputtering or the like. Then, a resist (photosensitive resin) is applied on the transparent conductive film by spin coating, and a resist pattern is formed by photolithography process. Using the resist pattern as a mask, the transparent conductive film is etched into a shape of a transparent electrode 9a or the like. Further, a metal thin film, which serves as a reflective electrode 9b, is deposited by sputtering or the like. A resist is applied on the metal thin film by spin coating, and a resist pattern is formed by photolithography process. Using the resist pattern as a mask, the metal thin film is etched into a shape of the reflective electrode 9b or the like. Alternatively, the transparent electrode 9a and the reflective electrode 9b may be formed in one photolithography process using multiphase exposure. In the multiphase exposure, a control of a resist film thickness is particularly important, and it is therefore necessary to prevent the coating unevenness from occurring when coating the resist by spin coating. A TFT array substrate is produced in the above-described process.

Further, an alignment layer is formed above the TFT array substrate which is produced as described above and a counter substrate such as a color filter. On the alignment layer, an alignment process (rubbing process) which forms micro scratches on a contact surface with liquid crystal in one direction is performed. Then, a sealing material is applied, and the TFT array substrate is bonded to the counter substrate. Specifically, the seal pattern 11 is formed in the TFT array substrate in such a way that the end portion of the seal pattern protrusion 12 is placed above the isolated pattern 20 inside the substantially U-shaped organic film removal area 161, and the TFT array substrate is superposed on the counter substrate. Alternatively, the seal pattern 11 may be formed in the counter substrate, and the counter substrate is superposed on the TFT array substrate in such a way that the end portion of the seal pattern protrusion 12 is placed above the isolated pattern 20.

Then, the seal pattern 11 is cured by applying a pressure so that the cell gap becomes a prescribed value, and the substrates are then cut into a plurality of panels 9 along the cutting-plane line 10. The seal pattern protrusion 12 is divided because it is formed across the cutting-plane line 10. Thus, in each panel 19 after cutting, a part of the seal pattern protrusion 12, which is a seal material that is the same as the seal pattern 11, remains on an edge side which is opposed to the edge side having an inlet. Further, liquid crystal is filled through the liquid crystal inlet using vacuum filling method or the like. Alternatively, the substrates may be cut into stick-like parts, and the liquid crystal filling may be performed on a plurality of panels 19. The liquid crystal passes between two protrusions and are filled inside the frame-like seal pattern. After that, a sealing resin is filled between the two protrusions, so that the liquid crystal inlet is sealed. The liquid crystal display device of this embodiment is thereby produced.

As described above, the substantially U-shaped organic film removal area 161 is formed to extend from the stripe-shaped organic film removal area 13 in this embodiment. If the organic film 8 is removed in such a shape, the organic film removal area in the area of the seal pattern protrusion 12 is reduced. Thus, when applying a resist (photosensitive resin) by spin coating in a subsequent step, the amount of the resist which is accumulated in this organic film removal area is reduced, thereby preventing the occurrence of coating unevenness. For example, it is possible to prevent the coating unevenness from occurring in the resist pattern when patterning the metal thin film or the transparent conductive film of the pixel electrode 9. The display device which includes the above-described panel can thereby prevent the occurrence of display unevenness, thereby improving a display quality and a yield.

### Second Embodiment

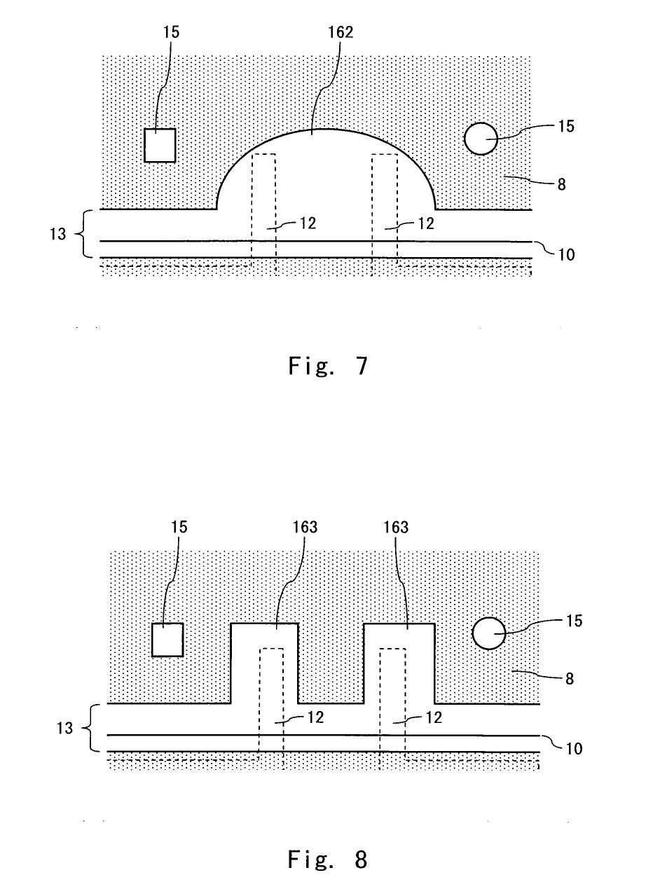

The patterned shape of the organic film 8 in the frame region 42 according to a second embodiment of the present invention is described hereinafter with reference to FIG. 7. FIG. 7 is a plane view showing organic film removal areas according to the embodiment, which shows the organic film removal area in the seal pattern protrusion 12 in an enlarged scale. In this embodiment, the shape of the organic film removal area in the area of the seal pattern protrusion 12 is different from that in the first embodiment. The other structure is the same as that of the first embodiment and thus not described herein. In FIG. 7, the seal pattern 11, which is formed in a subsequent panel bonding process, is indicated by a dotted line for convenience of description.

In FIG. 7, the stripe-shaped organic film removal area 13 is formed along the cutting-plane line 10 which is adjacent to the side of the seal frame having an inlet. Further, the organic film in the seal pattern protrusion 12 and its vicinity is removed in a circular shape (organic film removal area 162) so as to extend from the stripe-shaped organic film removal area 13 along the cutting-plane line 10. The organic film removal area 162 is widest between the two seal pattern protrusions. The width becomes narrower as it becomes farther from the midpoint between the two protrusion. Therefore, the boundary line of the organic film removal area 162 is a circular curved line. The peripheral edge of the organic film removal area 162 extends in a circular shape so as to form the wide portion. The seal pattern protrusion 12 is formed to across the cutting-plane line 10, and the end portion of the seal pattern protrusion 12 is placed within the organic film removal area 162, which is the position to serve as the wide portion.

A method of manufacturing the liquid crystal display device according to this embodiment is described hereinafter. The method of this embodiment is different from that of the first embodiment only in the process of forming the organic film 8, and the other process is the same and thus not described in detail herein. After depositing the organic film 8, it is patterned by photolithography process. In this step, a photomask having a different pattern from the first embodiment is used. Therefore, in the frame region 42, the organic film removal area which has a different shape from that of the first embodiment is formed. After that, the exposed part of the insulating film 7 is removed by dry etching. Then, in the panel bonding process after various subsequent processes, the seal pattern 11 is formed in such a way that the end portion of the seal pattern protrusion 12 is placed inside the circular-shaped organic film removal area 162. After bonding the panel, it is cut into a plurality of panels 19 along the cutting-plane line 10. Because the seal pattern protrusion 12 is formed across the cutting-plane line 10, a part of the seal pattern protrusion 12, which is a seal material that is the same as the seal pattern 11, remains on an edge side of each panel 19 which is opposed to the edge side having an inlet.

As described above, the circular-shaped organic film removal area 162 is formed to extend from the stripe-shaped organic film removal area 13 in this embodiment. If the organic film 8 is removed in such a shape, the organic film removal area in the area of the seal pattern protrusion 12 does not have a corner portion. Thus, when applying a resist by spin coating in a subsequent step, the resist is not easily accumulated in this organic film removal area, thereby preventing the occurrence of coating unevenness. For example, it is possible to prevent the coating unevenness from occurring in the resist pattern when patterning the metal thin film or the transparent conductive film of the pixel electrode 9. The display device which includes the above-described panel can thereby prevent the occurrence of display unevenness, thereby improving a display quality and a yield. Further, because the organic film 8 is not formed immediately below the seal pattern protrusion 12, it is possible to prevent the stripping of the seal pattern. Third embodiment The patterned shape of the organic film 8 in the frame region according to a third embodiment of the present invention is described hereinafter with reference to FIG. 8. FIG. 8 is a plane view showing organic film removal areas according to the embodiment, which shows the organic film removal area in the seal pattern protrusion 12 in an enlarged scale. In this embodiment, the shape of the organic film removal area in the area of the seal pattern protrusion 12 is different from that in the first and second embodiments. The other structure is the same as that of the first and second embodiments and thus not described herein. In FIG. 8, the seal pattern 11, which is formed in a subsequent panel bonding process, is indicated by a dotted line for convenience of description.

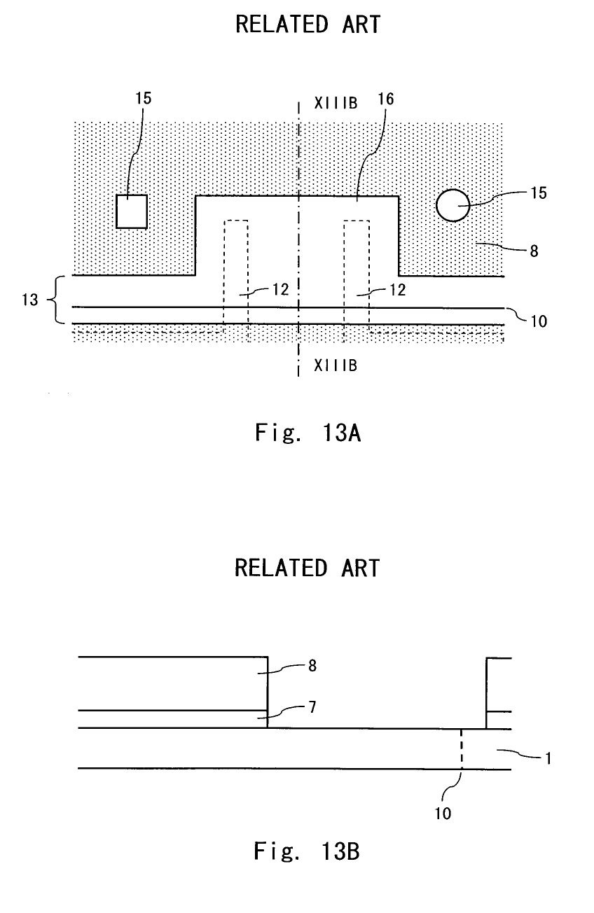

In FIG. 8, the stripe-shaped organic film removal area 13 is formed along the cutting-plane line 10 which is adjacent to the side of the seal frame having an inlet. Further, the organic film is removed in two projecting portions (organic film removal area 163) so as to extend from the stripe-shaped organic film removal area 13 along the cutting-plane line 10. Specifically, the organic film 8 only in each of the two seal pattern protrusions 12 and its vicinity is removed widely, so that two parts of the organic film removal areas 163 are formed. Thus, the organic film removal area 163 of this embodiment has a smaller width than the organic film removal area 16 of the related art shown in FIG. 13A. The organic film 8 remains without being removed between the two projecting organic film removal areas. Thus, the organic film 8 is placed between the two protrusions. The organic film 8 which is placed in the display region 41 extends to the area between the two protrusions. In the example of FIG. 8, the organic film removal area 163 is rectangular. The seal pattern protrusion 12 is formed across the cutting-plane line 10, and each seal pattern protrusion 12 is placed in each organic film removal area 163.

A method of manufacturing the liquid crystal display device according to this embodiment is described hereinafter. The method of this embodiment is different from that of the first and second embodiments only in the process of forming the organic film 8, and the other process is the same and thus not described in detail herein. After depositing the organic film 8, patterning is performed by photolithography process. In this step, a photomask having a different pattern from that of the first and second embodiments is used. Therefore, in the frame region 42, the organic film removal area which has a different shape from the first and second embodiments is formed. After that, the exposed part of the insulating film 7 is removed by dry etching. Then, in the panel bonding process after various subsequent processes, the seal pattern 11 is formed in such a way that the end portion of the seal pattern protrusion 12 is placed inside each of the projecting organic film removal areas 163. After bonding the panel, it is cut into a plurality of panels 19 along the cutting-plane line 10. Because the seal pattern protrusion 12 is formed across the cutting-plane line 10, a part of the seal pattern protrusion 12, which is a seal material that is the same as the seal pattern 11, remains on an edge side of each panel 19 which is opposed to the edge side having an inlet.

As described above, the two projecting organic film removal areas 163 are formed to extend from the stripe-shaped organic film removal area 13 in this embodiment. If the organic film 8 is removed in such a shape, the organic film removal area in the area of the seal pattern protrusion 12 is reduced. Thus, when applying a resist by spin coating in a subsequent step, the amount of the resist which is accumulated in this organic film removal area is reduced, thereby preventing the occurrence of coating unevenness. For example, this avoids the coating unevenness in the resist pattern when patterning the metal thin film or the transparent conductive film of the pixel electrode 9. The display device which includes the above-described panel can thereby prevent the occurrence of display unevenness, thereby improving a display quality and a yield. Further, because the organic film 8 is not placed immediately below the seal pattern protrusion 12, it is possible to prevent the stripping of the seal pattern.

### Fourth Embodiment

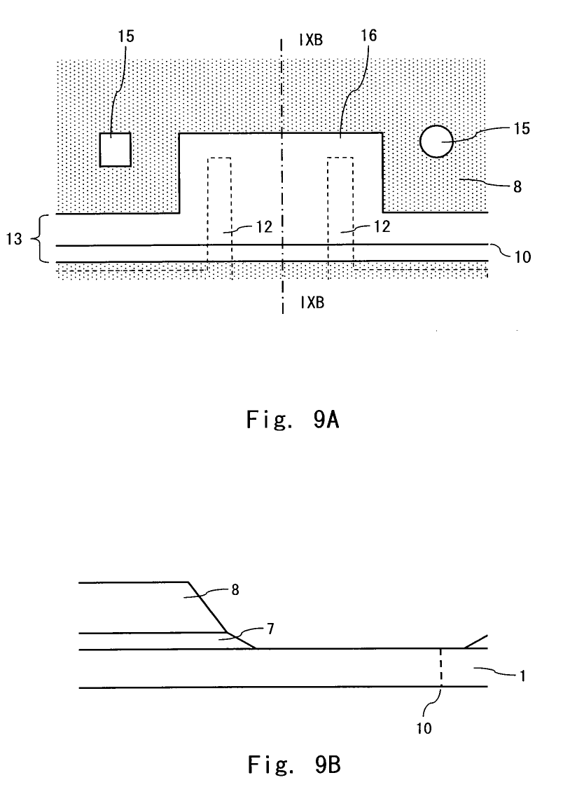

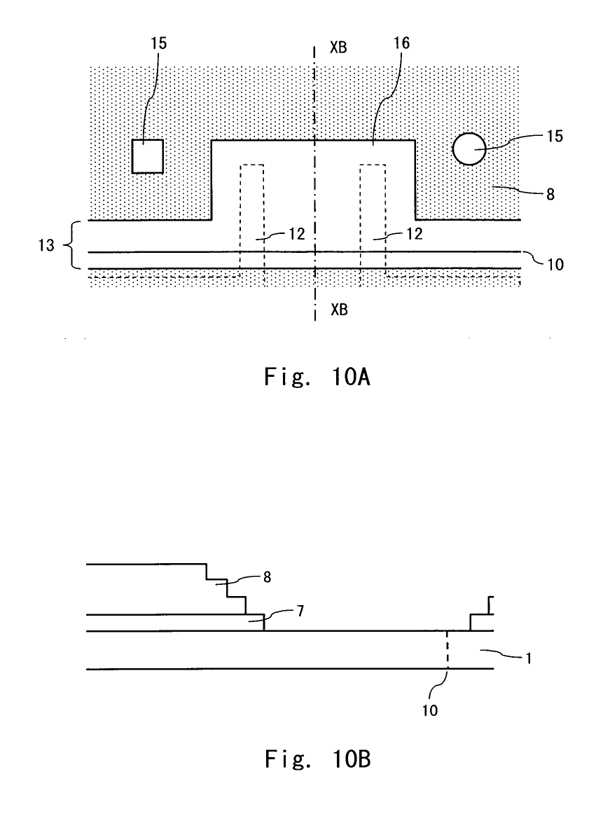

The patterned shape of the organic film in the frame region according to a fourth embodiment of the present invention is described hereinafter with reference to FIGS. 9A and 9B. FIG. 9A is a plane view showing organic film removal areas according to the embodiment, which shows the organic film removal area in the seal pattern protrusion 12 in an enlarged scale. FIG. 9B is a sectional view along line IXB-IXB in FIG. 9A. In this embodiment, the sectional shape of the organic film removal area in the frame region 42 is different from that in the first to third embodiments and the related art shown in FIG. 13B. The other structure is the same as that of the first to third embodiments and thus not described herein. In FIG. 9A, the seal pattern 11, which is formed in a subsequent panel bonding process, is indicated by a dotted line for convenience of description.

In FIG. 9A, just like the related art shown in FIG. 13A, the rectangular organic film removal area 16 is placed to extend from the stripe-shaped organic film removal area 13. The seal pattern protrusion 12 is formed across the cutting-plane line 10, and the end portion of the seal pattern protrusion 12 is placed within the rectangular organic film removal area 16. In this embodiment, the side face of the organic film removal area is slowly tapered with respect to the substrate as shown in FIG. 9B. Thus, the end portion of the organic film 8 which forms the side face of the organic film removal area 16 has a slightly tapered angle. Further, the end portion of the insulating film 7 which is placed below the organic film 8 also has a slightly tapered angle which corresponds to the end shape of the organic film 8. For example, the slope angle of the organic film 8 and the insulating film 7 which form the side face of the organic film removal area 16 is 60 degrees or smaller.

A method of manufacturing the liquid crystal display device according to this embodiment is described hereinafter. The method of this embodiment is different from that of the first to third embodiments only in the process of forming the organic film 8, and the other process is the same and thus not described in detail herein. After depositing the organic film 8, the method of this embodiment performs exposure with the use of a mask pattern having a slit pattern (slit pattern mask). In the slit pattern mask, slit patterns with the resolution of an exposure device or smaller are placed at intervals of the resolution or smaller. The method performs exposure by adjusting the light exposure using the above slit pattern mask, and then performs development. A smaller amount of exposure light is thereby applied to the periphery of the opening than to the opening, so that a slowly tapered shape is obtained. After that, the exposed part of the insulating film 7 is removed by dry etching. Because the organic film 8 is also removed together with the insulating film 7, the insulating film 7 after dry etching is a tapered shape which corresponds to the organic film 8 before dry etching.

Then, in the panel bonding process after various subsequent processes, the seal pattern 11 is formed in such a way that the end portion of the seal pattern protrusion 12 is placed inside the rectangular-shaped organic film removal area 16. After bonding the panel, it is cut into a plurality of panels 19 along the cutting-plane line 10. Because the seal pattern protrusion 12 is formed across the cutting-plane line 10, a part of the seal pattern protrusion 12, which is a seal material that is the same as the seal pattern 11, remains on an edge side of each panel 19 which is opposed to the edge side having an inlet.

As described above, the rectangular organic film removal area 16 is formed to extend from the stripe-shaped organic film removal area 13 in this embodiment. The side face of the organic film removal area 16 is slowly tapered with respect to the substrate. If the organic film 8 is removed in such a shape, the organic film removal area 16 in the area of the seal pattern protrusion 12 is not surrounded by steep edge faces but is smoothly connected to the organic film formation area. Thus, when applying a resist by spin coating in a subsequent step, the resist is not easily accumulated in the organic film removal area 16, thereby preventing the occurrence of coating unevenness. For example, this avoids the coating unevenness in the resist pattern when patterning the metal thin film or the transparent conductive film of the pixel electrode 9. The display device which includes the above-described panel can thereby prevent the occurrence of display unevenness, thereby improving a display quality and a yield.

### Fifth Embodiment

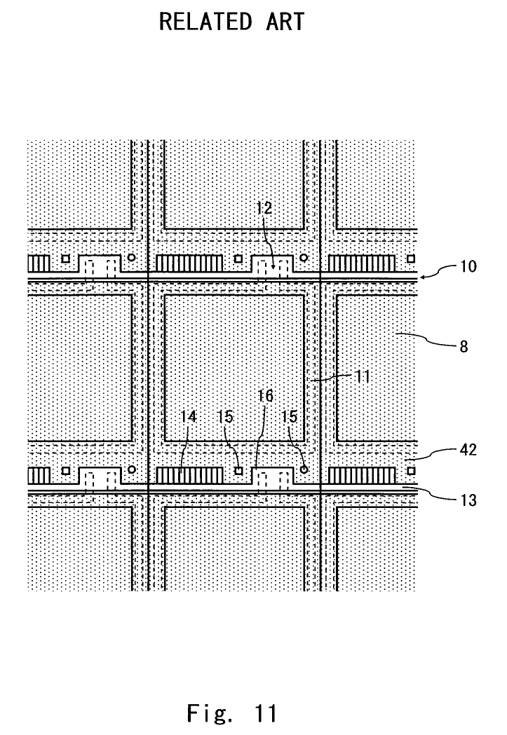

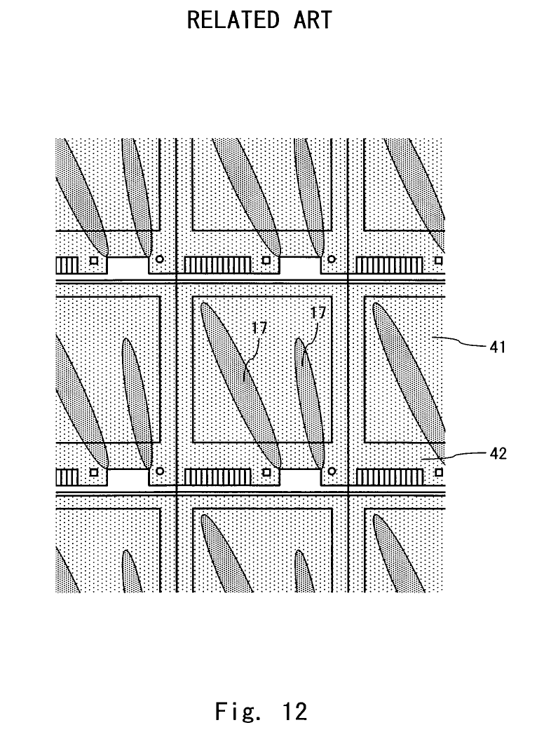

The patterned shape of the organic film in the frame region according to a fifth embodiment of the present invention is described hereinafter with reference to FIGS. 10A and 10B. FIG. 10A is a plane view showing organic film removal areas according to the embodiment, which shows the organic film removal area in the seal pattern protrusion 12 in an enlarged scale. FIG. 10B is a sectional view along line XB-XB in FIG. 10A. In this embodiment, the sectional shape of the organic film removal area in the frame region 42 is different from that in the first to fourth embodiments and the related art shown in FIG. 13B. The other structure is the same as that of the first to fourth embodiments and thus not described herein. In FIG. 10A, the seal pattern 11, which is formed in a subsequent panel bonding process, is indicated by a dotted line for convenience of description.

In FIG. 10A, just like the fourth embodiment and the related art shown in FIG. 13A, the rectangular organic film removal area 16 is placed to extend from the stripe-shaped organic film removal area 13. The seal pattern protrusion 12 is formed across the cutting-plane line 10, and the end portion of the seal pattern protrusion 12 is placed within the rectangular organic film removal area 16. In this embodiment, the side face of the organic film removal area 16 has a step-like shape as shown in FIG. 10B. In the example of FIG. 10B, the organic film 8 of three steps is formed on the insulating film 7 of one step.

A method of manufacturing the liquid crystal display device according to this embodiment is described hereinafter. The method of this embodiment is different from that of the first to fourth embodiments only in the process of forming the organic film 8, and the other process is the same and thus not described in detail herein. After depositing the organic film 8, the method of this embodiment performs exposure with the use of multi-tone exposure such as a halftone mask or a graytone mask. In these masks, an intermediate exposure portion exists between a shield portion and an exposure portion. In the intermediate exposure portion of the halftone mask, a filter film which reduces the transmission amount of light in a wavelength range used for exposure (generally, 350 to 450 nm) is placed. In the intermediate exposure portion of the graytone mask, a slit pattern with the resolution of an exposure device or smaller is placed in order to reduce the light exposure using optical diffraction. This method performs the exposure by adjusting the light exposure using the above mask, and then performs development. In this method, the intermediate exposure portion is exposed to the amount of exposure light which is smaller than the exposure portion and larger than the shield portion, so that a thin film portion with a small thickness is formed in the periphery of the organic film 8 pattern. The organic film 8 having a two-step shape is thereby formed. If a mask in which two kind of intermediate exposure portions (e.g. an intermediate exposure portion with a light transmission rate of 66%, an intermediate exposure portion with a light transmission rate of 33% etc.) having different characteristics in light transmission rate is placed between an exposure portion and a shield portion, the organic film 8 having a three-step shape can be formed as shown in FIG. 10B.

After that, the exposed part of the insulating film 7 is removed by dry etching. Because the organic film 8 is also removed together with the exposed part of the insulating film 7, the sectional shape in which one more step of insulating film is further added is obtained after dry etching. Then, in the panel bonding process after various subsequent processes, the seal pattern 11 is formed in such a way that the end portion of the seal pattern protrusion 12 is placed inside the rectangular-shaped organic film removal area 16. After bonding the panel, it is cut into a plurality of panels 19 along the cutting-plane line 10. Because the seal pattern protrusion 12 is formed across the cutting-plane line 10, a part of the seal pattern protrusion 12, which is a seal material that is the same as the seal pattern 11, remains on an edge side of each panel 19 which is opposed to the edge side having an inlet.

As described above, the rectangular organic film removal area 16 is formed to extend from the stripe-shaped organic film removal area 13 in this embodiment. The side face of the organic film removal area 16 has a step-like shape. If the organic film 8 is removed in such a shape, the organic film removal area 16 in the area of the seal pattern protrusion 12 is not surrounded by steep edge faces but is connected step-like to the organic film formation area. Thus, when applying a resist by spin coating in a subsequent step, the resist is not easily accumulated in the organic film removal area 16, thereby preventing the occurrence of coating unevenness. For example, this avoids the coating unevenness in the resist pattern when patterning the metal thin film or the transparent conductive film of the pixel electrode 9. The display device which includes the above-described panel can thereby prevent the occurrence of display unevenness, thereby improving a display quality and a yield.

Although the case where the organic film removal area in the area of the seal pattern protrusion has a rectangular shape, which is the same as the related art, is described in the fourth and fifth embodiments above, the organic film removal area may have another shape, such as the shapes which are described in the first to third embodiments.

Further, although an active matrix liquid crystal display device which includes a TFT array substrate is described by way of illustration in the first to fifth embodiments above, a passive matrix liquid crystal display device may be used instead. Although the resist which is coated in a subsequent process of the organic film 8 is removed after it is used as a mask for etching the layer formed therebelow, the resist may be not removed to constitute the liquid crystal display device. Furthermore, although the pixel electrode 9 is formed using the pattern of the resist which is coated in a subsequent process of the organic film 8, another element of the liquid crystal display device, different from the pixel electrode 9, may be formed. A liquid crystal display device is not necessarily transflective as long as it uses the organic film 8.

The explanation provided above merely illustrates the embodiments of the present invention, and the present invention is not limited to the above-described embodiments. A person skilled in the art will be able to easily change, add, or modify various elements of the above-described embodiments, without departing from the scope of the present invention.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A liquid crystal display device comprising:
an organic film placed above a substrate; and
a seal pattern placed above the organic film and surrounding a display region, the seal pattern having a liquid crystal inlet seal pattern for filling of liquid crystal, wherein
an organic film removal area where the organic film is removed exists along an edge side of the substrate,
a wide portion where the organic film removal area is wide exists at an edge side opposed to an edge side having the liquid crystal inlet,
a pattern of a seal material being the same as the seal pattern is placed in the wide portion, and
a boundary between the organic film and the wide portion of the organic film removal area includes a curve.

2. A liquid crystal display device comprising:
an organic film placed above a substrate; and
a seal pattern placed above the organic film and surrounding a display region, the seal pattern having a liquid crystal inlet seal pattern for filling of liquid crystal, wherein
an organic film removal area where the organic film is removed exists along an edge side of the substrate,
a wide portion where the organic film removal area is wide exists at an edge side opposed to an edge side having the liquid crystal inlet,
two seal materials being the same as the seal pattern are formed in the wide portion, and
the organic film is placed between the two seal materials.

3. A liquid crystal display device comprising:
an organic film placed above a substrate; and
a seal pattern placed above the organic film and surrounding a display region, the seal pattern having a liquid crystal inlet seal pattern for filling of liquid crystal, wherein
an organic film removal area where the organic film is removed exists along an edge side of the substrate,
the organic film includes an island-shaped isolated pattern placed separately from the organic film inside the display region, and
a seal material being the same as the seal pattern is placed above the isolated pattern.

4. The liquid crystal display device according to claim 3, wherein
the organic film removal area is formed to surround the island-shaped isolated pattern, in width of 5 μm or smaller.

5. A liquid crystal display device comprising:
an organic film placed above a substrate; and
a seal pattern placed above the organic film and surrounding a display region, the seal pattern having a liquid crystal inlet seal pattern for filling of liquid crystal, wherein
an organic film removal area where the organic film is removed exists along an edge side of the substrate,
a wide portion where the organic film removal area is wide exists at an edge side opposed to an edge side having the liquid crystal inlet,
a pattern of a seal material being the same as the seal pattern is placed in the wide portion, and
an edge face of the organic film is tapered or step-like at a boundary between the organic film and the wide portion of the organic film removal area.

6. A method of manufacturing a liquid crystal display device that forms a seal pattern having a liquid crystal inlet seal pattern across a cutting-plane line above a mother substrate where a plurality of panels are arranged in matrix with the cutting-plane line interposed therebetween and cuts the mother substrate at the cutting-plane line into the plurality of panels, comprising:
coating an organic film over the mother substrate;
patterning the organic film to form an organic film removal area placed along the cutting-plane line and including a wide portion where the organic film removal area is wide with a boundary with the organic film being curved;
coating a photosensitive resin over the patterned organic film;
forming a seal pattern surrounding a display region of each panel above the mother substrate and forming the liquid crystal inlet seal pattern in the wide portion of an adjacent panel; and
cutting the mother substrate at the cutting-plane line so as to divide the liquid crystal inlet seal pattern.

7. A method of manufacturing a liquid crystal display device that forms a seal pattern having two liquid crystal inlet seal patterns across a cutting-plane line above a mother substrate where a plurality of panels are arranged in matrix with the cutting-plane line interposed therebetween and cuts the mother substrate at the cutting-plane line into the plurality of panels, comprising:
coating an organic film over the mother substrate;
patterning the organic film to form an organic film removal area placed along the cutting-plane line and including a wide portion where the organic film removal area is wide;
coating a photosensitive resin over the patterned organic film;
forming a seal pattern surrounding a display region of each panel above the mother substrate and forming the liquid crystal inlet seal pattern in the wide portion of an adjacent panel in such a way that the organic film is placed between the two liquid crystal inlet seal patterns; and
cutting the mother substrate at the cutting-plane line so as to divide the liquid crystal inlet seal patterns.

8. A method of manufacturing a liquid crystal display device that forms a seal pattern having a liquid crystal inlet seal pattern across a cutting-plane line so as to surround a display region above a mother substrate where a plurality of panels are arranged in matrix with the cutting-plane line interposed therebetween and cuts the mother substrate at the cutting-plane line into the plurality of panels, comprising:
coating an organic film over the mother substrate;
patterning the organic film to form an organic film removal area placed along the cutting-plane line and an island-shaped isolated pattern adjacent to the organic film removal area and separated from the organic film inside the display region;
coating a photosensitive resin over the patterned organic film;
forming a seal pattern surrounding a display region of each panel above the mother substrate and forming the liquid crystal inlet seal pattern in the island-shaped isolated pattern of an adjacent panel; and
cutting the mother substrate at the cutting-plane line so as to divide the liquid crystal inlet seal pattern.

9. A method of manufacturing a liquid crystal display device that forms a seal pattern having a liquid crystal inlet seal pattern across a cutting-plane line above a mother substrate where a plurality of panels are arranged in matrix with the cutting-plane line interposed therebetween and cuts the mother substrate at the cutting-plane line into the plurality of panels, comprising:
coating an organic film over the mother substrate;
patterning the organic film to form an organic film removal area placed along the cutting-plane line and including a wide portion where the organic film removal area is wide in such a way that the organic film has a tapered or step-like edge face at a boundary between the organic film and the wide portion;
coating a photosensitive resin over the patterned organic film;
forming a seal pattern surrounding a display region of each panel above the mother substrate and forming the liquid crystal inlet seal pattern in the wide portion of adjacent panels; and
cutting the mother substrate at the cutting-plane line so as to divide the liquid crystal inlet seal pattern.

10. The method of manufacturing a liquid crystal display device according to claim 9, wherein
in the step of patterning the organic film, the pattering is performed using a slit pattern mask having a slit pattern or multi-tone exposure.
